(19) United States
(12) Patent Application Publication
(10) Pub. No.: US 2015/0305003 A1
(43) Pub. Date: Oct. 22, 2015

(54) MULTIPLEXED TRANSMISSION OF DATA FROM MULTIPLE HARQ PROCESSES FOR A SWITCHING OPERATION

(71) Applicants: Tao CHEN, (US); Chunyan GAO, (US); Jing HAN, Beijing (CN); Wei HONG, Beijing (CN)

(72) Inventors: Tao Chen, Espoo (FI); Chunyan Gao, Beijing (CN); Jing Han, Beijing (CN); Wei Hong, Beijing (CN)

(21) Appl. No.: 14/439,486

(22) PCT Filed: Oct. 31, 2012
(86) PCT No.: PCT/CN2012/083829

§ 371 Date: Apr. 29, 2015

(51) Int. Cl. H04W 72/04; H04L 1/18

(52) U.S. Cl. CPC H04W 72/044; H04W 72/042; H04L 1/1812

(57) ABSTRACT

A network sends data blocks in a first/n1h radio frame having a first configuration of uplink to downlink transmission time intervals TTIs. Each of these data blocks originate a separate hybrid automatic repeat request HARQ process. The network then frequency or spatially mutliplexes first re-transmissions of at least two of the data blocks in at least one TTI of a sequentially next second/(n+1)^{st} radio frame having a different second configuration of uplink to downlink TTIs. If necessary second re-transmissions of the HARQ processes can also be similarly multiplexed in a TTI of a third/(n+2)^{nd} radio frame sequentially next after the second/(n+1)^{st} frame. In the examples, if frequency domain multiplexing the frequency mutliplexed first re-transmissions are separately scheduled; or if spatial domain multiplexing the spatially mutliplexed first re-transmissions are scheduled with a single physical downlink control channel PDCCH.

### TECHNICAL FIELD

The exemplary and non-limiting embodiments of this invention relate generally to wireless communication systems, methods, devices and computer programs and, more specifically, relate to multiplexing of data from different HARQ processes even when the uplink/downlink configuration of a frame is switched.

### BACKGROUND

Time division duplexing (TDD) enables flexible deployments of radio spectrum without requiring that the spectrum resources must be paired. In the Long Term Evolution (LTE) of the UTRAN system (LTE is also known as E-UTRAN), the TDD deployment allows for asymmetric frame allocations as to the number of uplink (UL) and downlink (DL subframes are in a frame. More specifically, LTE TDDF provides seven different UL-DL configurations that are semi-statically configured, which can provide between 40% and 90% DL subframes. The current mechanism for adapting the UL-DL allocation is based on a change in broadcast system information (SI). But the UL-SL configuration can be changed only semi-statically and so at a given time the current configuration may not match the instantaneous traffic situation. Since the conclusion of 3GPP TR 36.388 v11.0.0 (2012-06) it is no longer feasible to consider flexible UL-DL switching with frame reconfiguration via SI. But the issue of dynamic UL-DL subframe allocations remains open through other means apart from SI, and the 3GPP has opened up a work item to explore other options.

Hybrid automatic repeat request (HARQ) is a well known technique for ensuring the intended recipient receives the intended data that was transmitted. In short, if the receiver successfully receives a packet or block of data it will send an acknowledgement (ACK) to the sender at a specific time/subframe mapped from some earlier time/subframe that is tied to the data in some way. In LTE, the ACK maps to the subframe that scheduled the resource/subframe in which the data was sent. If the sender does not receive the ACK on time it considers that to be a negative acknowledgment (NACK) and re-sends the packet or block of data at a subframe which is given by a HARQ process. This first re-transmission will also generate an ACK or NACK from the receiver, and if again there is a NACK then the HARQ process defines another subframe for a second re-transmission of the data. This is one HARQ process. Multiple HARQ processes can be ongoing at once since there is a time delay from the data packet/block to the ACK/NACK, and before that first HARQ process is completed other data packets/blocks can be sent which can each ground their own ARQ process.

In LTE, since there are only a certain number of UL and DL subframes per frame, there is a physical limit to the maximum number of HARQ processes that can be ongoing simultaneously for a given user equipment (UE). In the current 3GPP specifications there is only one HARQ process corresponding to one transmission time interval (TTI) for a UE, and the maximum number of HARQ processes is differs for different TDD frame configurations (quite a bit). Further detail as to HARQ processes in the LTE system may be seen at 3GPP TS 36.331 V11.0.0 (2012-06); TS36.321 V10.5.0 (2012-03), and TS 36.213 V10.5.0 (2012-03).

The above overview makes clear that if when performing frame UL-DL reconfiguration for flexible TDD switching, it is possible that the maximum number of HARQ process corresponding to the new frame configuration is less than the number of active HARQ processes that have pending HARQ re-transmissions in the previous frame following the old frame configuration. If this were allowed the ACK/NACK and re-transmission timing for at least some HARQ processes would no longer be unequivocal, and may lead to some unexpected behavior by the UE and by the network access node (eNB). Embodiments of these teachings resolve these issues.

### SUMMARY

In a first exemplary aspect of the invention there is a method for controlling a wireless network access node, comprising: sending data blocks in a first radio frame having a first configuration of uplink to downlink transmission time intervals, each data block originating a separate hybrid automatic repeat request HARQ process; and frequency or spatially mutliplexing re-transmissions of at least two of the data blocks in at least one transmission time interval of a sequentially next second radio frame having a second configuration of uplink to downlink transmission time intervals.

In a second exemplary aspect of the invention there is an apparatus for controlling a wireless network access node. In this aspect the apparatus comprises a processing system, and the processing system comprises at least one processor and a memory storing a set of computer instructions. The processing system is configured to cause the apparatus at least to: send data blocks in a first radio frame having a first configuration of uplink to downlink transmission time intervals, each data block originating a separate hybrid automatic repeat request HARQ process; and frequency or spatially mutliplex re-transmissions of at least two of the data blocks in at least one transmission time interval of a sequentially next second radio frame having a second configuration of uplink to downlink transmission time intervals.

In a third exemplary aspect of the invention there is a computer readable memory tangibly storing a set of computer executable instructions for controlling a wireless network access node. In this aspect the set of computer executable instructions comprises: code for sending data blocks in a first radio frame having a first configuration of uplink to downlink transmission time intervals, each data block originating a separate hybrid automatic repeat request HARQ process; and code for frequency or spatially mutliplexing re-transmissions of at least two of the data blocks in at least one transmission time interval of a sequentially next second radio frame having a second configuration of uplink to downlink transmission time intervals.

These and other aspects are detailed below with more particularity.

### BRIEF DESCRIPTION OF THE DRAWINGS

FIG. 1 is a table summarizing all of the possible switching scenarios in LTE for the seven possible UL/DL configurations of a radio frame, and indicting specifically which configuration switching will cause problems with conventional HARQ procedures.

FIG. 2 illustrates two radio frames and a portion of a third across which seven HARQ processes are extended with frequency or spatial multiplexing to account for the configuration switching between frame n and frame (n+1) according to an exemplary but non-limiting embodiment of these teachings.

FIG. 3 is a logic flow diagram that illustrates a method for operating a wireless network access node, and a result of execution by an apparatus of a set of computer program instructions embodied on a computer readable memory for operating such a network, in accordance with certain exemplary embodiments of this invention.

FIG. 4 is a simplified block diagram of a UE and an eNB which are exemplary electronic devices suitable for use in practicing the exemplary embodiments of the invention.

### DETAILED DESCRIPTION

The examples detailed herein are in the context of the LTE system but that is only to provide a practical context to describing the inventive concepts; these teachings may be utilized in other radio access technologies (RATs) which use the concept of automatic repeat request processes for data re-transmission purposes, whether such RATs utilize their whole bandwidth as one carrier or if they utilize multiple aggregated carriers where individual HARQ processes might not be confined to a single carrier where the frame UL-DL configuration might be changed. A wide variety of RATs use some form of the HARQ concept and these teachings are readily adapted to any of them that also allow changing the UL-DL configuration while a HARQ process might be ongoing.

Consider two specific examples from LTE in which a UL-DL reconfiguration can exceeds the maximum number of HARQ processes. The TDD configuration 1 allows a maximum of 7 HARQ processes and configuration 0 allows a maximum of 4 HARQ processes. If there were 6 HARQ processes ongoing when the configuration is changed from 1 to 0, there would be an extra 2 HARQ processes with pending HARQ re-transmission which cannot be handled in the new configuration 0.

It is possible to estimate the number of HARQ process with a pending re-transmission as follows, where BLER=block error rate and the number of codewords corresponds to the multiple input/multiple output MIMO transmission scheme.

Num. of remaining HARQ processes=Active_HARQ_Process_Num*BLER_Target*Num_Codewords_Per_Process.

Assuming there are 9 active HARQ processes for TDD configuration 3 (which supports a maximum of 9 HARQ processes) with 30% BLER target and two codewords MIMO transmission, then Num_error packets=7*0.3*2=5.5. Assuming they are evenly distributed over the HARQ processes, this corresponds to 5 HARQ processes with pending HARQ re-transmission. Then when switching to TDD configuration 0, these 5 HARQ processes would not be aligned with the allowed maximum of 4 HARQ process for the new configuration 0.

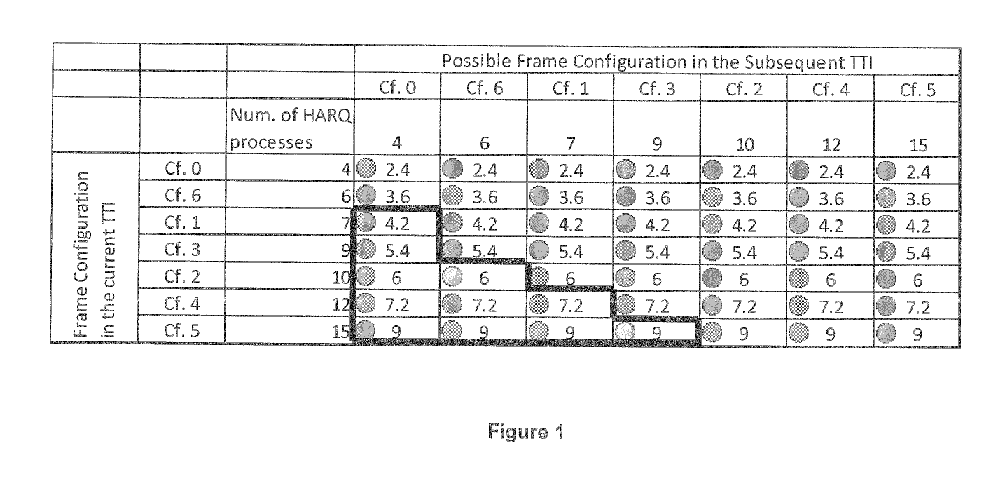

FIG. 1 is a table summarizing all of the possible switching scenarios in LTE for the 7 possible frame UL/DL configurations. The leftmost column lists the UL/DL frame configuration in the current TTI, and the topmost row lists the UL/DL frame configuration which is being switched to in the next TTI. The problematic cases with respect to HARQ processes are outlined in bold. The estimation is based on the assumption of 30% BLER target and two codewords MIMO transmission. Beyond only the problematic cases in FIG. 1, when considering varying channel conditions, the number of UEs, and the frequency of switching, then this HARQ problem may affect the operation and the performance of flexible switching more generally.

There are some simple solutions to this HARQ process problem when switching the frame configuration. The problem may be avoided by flushing all the HARQ process buffers during TDD configuration switching. In this case, for any packets that not correctly received the eNB can simply re-schedule them as a new transmission (in LTE the eNB would do this by setting the new data indicator NDI as toggled). Or a less drastic option is that, for the case where the number of ongoing HARQ processes is larger than the maximum HARQ process number of the switched TDD configuration, only flush the buffer(s) for the extra HARQ process(es). The UE will regard this as the re-transmission of corresponding DL processes, and combine received packets with those packets in a corresponding HARQ process buffer that was used in the old TDD configuration.

But these solutions are not seen to be optimal. Specifically, while they may solve the problem they are likely to cause some packet loss and/or some extra radio link control (RLC) re-transmissions. The solutions detailed below provide more optimized solutions to solve the above problem with HARQ processes when switching the frame configuration.

Specifically, these teachings resolve the above HARQ ₚroblems by multiplexing in the frequency or in the spatial domains (FDM or SDM) to one TTI, HARQ re-transmissions of multiple HARQ processes. In an embodiment this is limited to only those times where there is a switch to the frame configuration such that the a allowed maximum number of HARQ process in the subsequent frame is less than the number of active HARQ processes with pending HARQ re-transmissions in the current frame during the TDD frame configuration switching period.

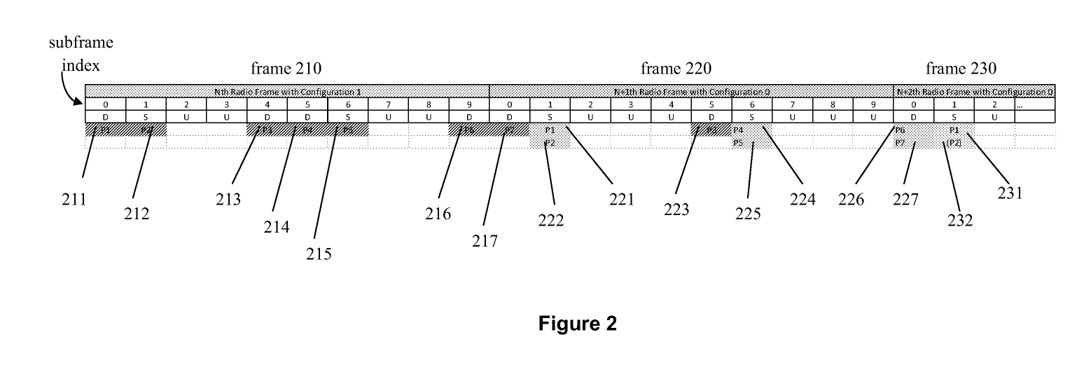

Before exploring some exemplary implementation details, FIG. 2 illustrates the general concept. There are three LTE radio frames illustrated: frame 210 is the first or n^{th} radio frame, frame 220 is the sequentially next second or (n+1)^{st} radio frame, and frame 230 is the sequentially next third or (n+2)^{nd} radio frame, where n can represent any integer system frame number (SFN). The UL/DL switch occurs between frames 210 and 220, from configuration 1 in frame 210 to configuration 0 in frame 220. There is no further switch in FIG. 1 so frame 230 is also UL/DL configuration 0. Referring back to FIG. 1, configuration 1 allows a maximum of 7 HARQ processes, while configuration 0 allows a maximum of 4 HARQ processes. For demonstration purposes FIG. 2 assumes there are 7 HARQ processes ongoing at the time of the frame configuration switch.

The row in FIG. 2 bearing indices 0 though 9 gives the subframe indices, and the row below that with designators D, U and S identify the subframe for the corresponding column as downlink, uplink, or a switching subframe. Switching subframes can be used for downlink data. The seven HARQ processes are identified as P1, P2, . . . P7.

For this example the first frame 210 shows the original transmission of data for each of those seven HARQ processes as follows:
P1 at reference number 211 is the original data transmission for a first HARQ process and occurs in subframe 0 of frame 210;
P2 at reference number 212 is the original data transmission for a second HARQ process and occurs in subframe 1 of frame 210;
P3 at reference number 213 is the original data transmission for a third HARQ process and occurs in subframe 4 of frame 210;
P4 at reference number 214 is the original data transmission for a fourth HARQ process and occurs in subframe 5 of frame 210;
P5 at reference number 215 is the original data transmission for a fifth HARQ process and occurs in subframe 6 of frame 210;
P6 at reference number 216 is the original data transmission for a sixth HARQ process and occurs in subframe 9 of frame 210; and
P7 at reference number 217 is the original data transmission for a seventh

HARQ process and occurs in subframe 0 of frame 211.

While rare in practice, for purposes of this example further assume that all seven of the HARQ processes are pending at the end of subframe 210; that is, each has drawn a NACK and the eNB needs to do a first re-transmission of data for each of those seven HARQ processes. But in this case the UL/DL configuration has switched so the next subsequent frame 220 has configuration 0 and only subframes 0, 1, 5 and 6 are the only subframes in which those first re-transmissions can be sent downlink. It is true that the original transmission 217 of the seventh HARQ process actually occurs in subframe 0 of frame 220 but this is conventional for HARQ in certain frame configurations, and is fully accounted for in the maximum number of allowed HARQ processes per configuration as shown at FIG. 1.

The first re-transmissions of the data (sometimes termed the error packet since in some systems it is not an identical re-transmission of the original) for these seven HARQ processes are then identified in FIG. 2 as follows:
P1 at reference number 221 is the first re-transmission of original data 211 for the first HARQ process and occurs in subframe 1 of frame 220, the next available subframe for downlink;
P2 at reference number 222 is the first re-transmission of original data 212 for the second HARQ process and is multiplexed with re-transmission 221 in subframe 1 of frame 220 via frequency division multiplexing (FDM) or spatial division multiplexing (SDM);
P3 at reference number 223 is the first re-transmission of original data 213 for the third HARQ process and occurs in subframe 5 of frame 220, the next available subframe for downlink;
P4 at reference number 224 and P5 at reference number 225 are the first re-transmissions of respective original data 214 and 215 for the respective fourth and fifth HARQ processes, and are multiplexed together in subframe 6 of frame 220 via FDM or SDM; and
P6 at reference number 226 and P7 at reference number 227 are the first re-transmissions of respective original data 216 and 217 for the respective sixth and seventh HARQ processes, and are multiplexed together in sub frame 0 of frame 230 via FDM or SDM.

Since in the LTE protocol the HARQ processes continue through a second re-transmission, for the FIG. 2 example assume the first re-transmissions of the second through seventh HARQ processes were successfully received and ACK'd, leaving only a need to send a second re-transmission 231 for the first HARQ process. This occurs in subframe 1 of frame 230, since subframe 0 of frame 230 is already occupied with two first re-transmissions 226 and 227. If the second HARQ process also needed a second re-transmission 232 (as shown in FIG. 2 by the parentheses about P2) it would be FDM or SDM multiplexed with the second re-transmission 231 in subframe 1 of frame 230.

Consider a specific example for FDM multiplexing for the first re-transmissions 221 and 222 of the first and second HARQ process in subframe 1 of frame 220. In this case, the eNB would use two physical downlink control channels (PDCCHs) to separately schedule these respective re-transmissions 221, 222 from different HARQ processes. The UE that supports this HARQ multiplexing can decode both transport blocks and combine the data in the buffer indicated by the HARQ process ID. This also implies that the same HARQ process ID would be kept after the switching of the frame configuration. Assuming as above that the first re-transmission 222 for the second HARQ process was successful and properly ACK'd, then in subframe 1 of radio frame 230 there would be only one HARQ process (P1) remaining that needs a second re-transmission 231. This results in a gradual return to the conventional (non-multiplexed) HARQ operation in which there is only one associated HARQ process per TTI/subframe.

Now consider that same example where the first re-transmissions 221 and 222 of the first and second HARQ process are multiplexed in subframe 1 of frame 220, but in this case the multiplexing is SDM. In this case the eNB would only send one PDCCH but will use a MIMO operation to obtain the spatial multiplexing. For example, if there is only one transport block for re-transmission per HARQ process, two transport blocks from two HARQ processes can be multiplexed by this MIMO operation and transmitted in one TTI as shown at subframe 1 of radio frame 220. In this case, a new DCI format would be needed to include the information for the additional HARQ process ID. Such new DCI formats are detailed more particularly below.

Consider a further example: there is a NACK for HARQ process P1 and for HARQ process P2. The eNB could schedule in one TTI a transport block with some of the first re-transmission data for P1 along with some of the first re-transmission data for P2, and schedule in another TTI the remainder of the first re-transmission data for P1 along with the remainder of the first re-transmission data for P2. This can be done with the conventional frame configurations, and is advantageous if the combination of two transport blocks from two HARQ processes is more suitable for the scheduled TBs to maximize the performance. In this case, the transport block index associated with the HARQ process ID would be used to identify the HARQ buffer. Because the transport block size per stream depends on the instantaneous channel condition the eNB may choose this technique as the way to fill the transport blocks most efficiently.

Should these teachings be embodied in some radio access technology which supports legacy UEs, it is advantageous to have some signaling to inform the network/eNB that a given UE supports multiplexing of HARQ re-transmissions as detailed by example above. More specifically, the compatible UE can indicate to the network the maximum number of HARQ processes with multiplexing that it can handle for reception. This is because the multiple transport blocks (TBs) from too many HARQ processes in one TTI may not provide sufficient time for processing by the non-compatible UEs, since there is no change in the examples above to the timing for the ACKs that the UE sends in response to the re-transmitted HARQ data. To support this feature, the underlying radio access technology protocol/standards can specify a minimum number of HARQ processes for multiplexing as the minimum requirement for UEs that are to be compatible with this HARQ re-transmission multiplexing. That is, if the indication is as little as one bit it can indicate that the signaling UE meets the minimum specified in the wireless standard, This also ensures that such compatibility can be tested by UE manufacturers.

Frame configuration switching is most useful when there is a high volume of traffic in a cell. For this reason it is also advantageous that the network/eNB have the option to enable or disable the HARQ multiplexing feature for a specific cell, or even for a specific UE. The eNB can utilize broadcast (cell-wide) or dedicated (UE-specific) radio resource control (RRC) signaling to indicate whether the HARQ multiplexing feature is configured or not for a cell or for a UE.

Once this feature is configured, implicit signaling can be used to trigger it. There are several ways for such implicit triggering. For example, the switching from a TDD configuration with a higher maximum number of HARQ processes to another TDD configuration with a lower maximum number of HARQ processes can be used as one implicit trigger for the UEs which have indicated to the eNB that they are capable of HARQ-multiplexing. In another example the HARQ-multiplexing feature can be implicitly triggered only when the eNB has more HARQ processes to re-transmit (pending HARQ processes) than that can be supported by the new TDD configuration.

Either of these or other implementations can also incorporate an activation timer, configured by the eNB for a UE or for all UEs in the cell, to indicate the valid period for the feature that is enabled by the implicit signaling. For example, in case of SDM multiplexing as described below, the UE would not detect the old downlink control information (DCI) formats until the activation timer is expired.

For SDM multiplexing for a UE with MIMO-related transmission-mode (TM) configuration, in one implementation of these teachings there are new DCI formats which for example could be extensions of the existing MIMO related DCIs (for example, DCI formats 212A/2B/2C), where the extensions add a field for one more process identifiers (for example, 4 bits) which identify up to two processes for simultaneous transmission. These extensions can also include a field for a TB index (for example, 1 bit per HARQ process) that indicates first or second TB in the previous transmission associated with the process ID. Specifically, the process ID with the TB index can be used to identify the unique HARQ buffer to be used.

These new DCIs can be used as follows. If the multiplexing feature is enabled, the UE would monitor the new DCI formats in addition to DCI format 1/1A/1B/1C. Otherwise, the UE would only monitor the old DCI formats. In this manner there is no increase in the total number of DCI formats a UE is required to monitor. If for example multiplexing feature is enabled and one of the HARQ process IDs is “1111” in new DCI (this value is currently not used in LTE), it means there is no multiplexing of multiple HARQ processes. Then the UE can recognize from this ID that the packets(s) are from one HARQ process indicated by the other HARQ process ID, meaning that it corresponds to the legacy MIMO transmission with only one HARQ process and additionally the UE does not need to attempt any blind detection of the corresponding old DCI since the new DCI can already cover the usage of the old DCI regardless of FDM/SDM multiplexing of multiple HARQ processes.

The UE supporting the feature of multiplexed data transmission from multiple HARQ processes, when the feature is configured by the eNB for the UE, can then receive multiple PDCCH channels corresponding to multiple PDSCH data transmissions/re-transmissions. If the DCI format is one of the conventional formats (for example, DCI format 1/1A/1B/1C/1D), then the UE can combine the data in the buffer indicated by the associated HARQ process ID. If the DCI format is one of the new formats noted above as having the extension fields (for example, extensions of DCI format 2/2A/2B/2C/2D), then UE would combine the data in the buffer indicated by the associated process ID and the TB index. If needed, the UE can set the HARQ process ID associated with the current TTI, meaning multiple HARQ processes could be associated with one TTI. All of these specific UE behaviors for implementing these teachings can be specified in a wireless protocol to ensure there is a common understanding among the UEs and the network eNBs for how to handle the multiplexed HARQ data.

Embodiments of these teachings provide the technical effect of keeping ₜhe HARQ gain and not increasing packet loss while maintaining a smooth HARQ operation during frame reconfigurations. There is a very low cost in signaling and more information may be needed for new DCI formats in case of supporting SDM multiplexing and latency (for example, 6 bits of which 4 bits are for one more HARQ process ID and 1 bit is for the TB index per HARQ process). Implementing these teachings need not result in any increase in the UE's blind detection attempts since the number of DCI formats for the UE to detect at any given time is not increased. These teachings should be relatively simple to adopt into legacy wireless technologies and still they offer quite a bit of flexibility for the eNB's scheduling point of view.

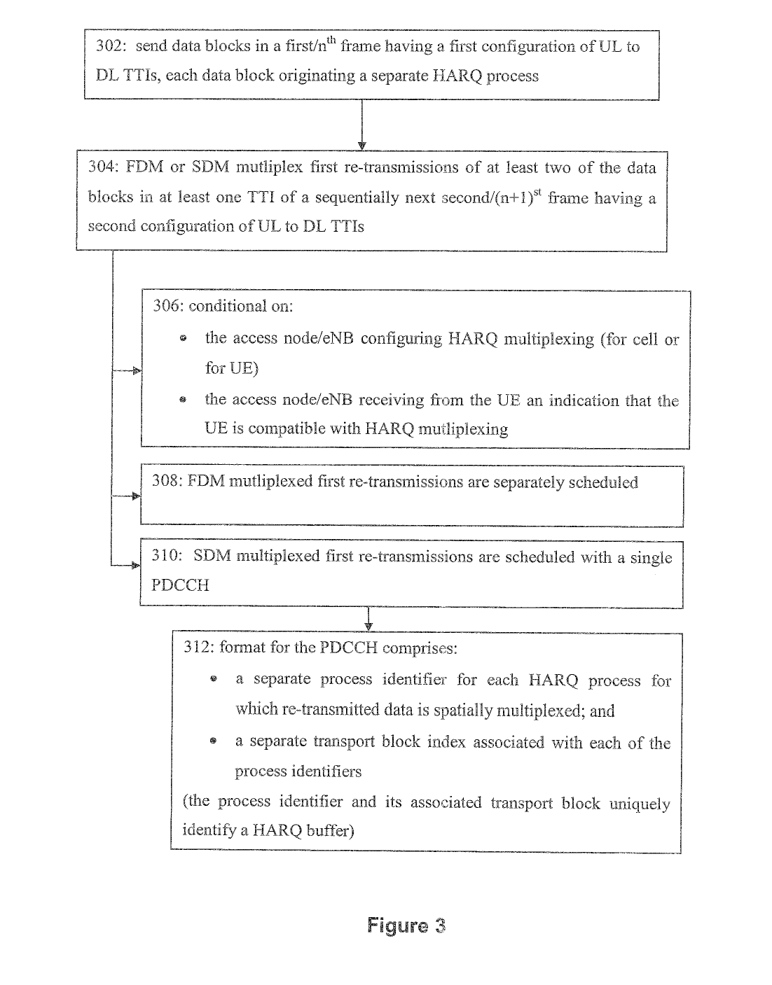

FIG. 3 presents a summary of the above teachings for controlling and for operating a wireless network access node such as for example an eNB operating in a LTE or LTE-Advanced (LTE-A) network. At block 302 the eNB (or some one or more components controlling the eNB) send data blocks in a first radio frame (an n^{th} radio frame) having a first configuration of uplink to downlink transmission time intervals, each data block originating a separate hybrid automatic repeat request HARQ process. Then at block 304 the eNB or component(s) thereof frequency or spatially mutliplex first re-transmissions of at least two of the data blocks in at least one transmission time interval of a sequentially next second radio frame [an (n+1)^{st} radio frame] having a second configuration of uplink to downlink transmission time intervals. The examples above further detail similar multiplexing for second re-transmissions of data blocks where it occurs that also second re-transmissions need to be FDM or SDM multiplexed, which would then occur in a third radio frame sequentially next after the second radio frame [the (n+2)^{nd} radio frame].

Some of the non-limiting implementations detailed above are also summarized at FIG. 3 following block 304. Block 306 specifies that the FSM/SDM multiplexing of block 304 is conditional on a) the wireless network access node/eNB configuring HARQ multiplexing (which can be configured cell-wide or for specific UEs), and b) the network access node/eNB receiving from the UE an indication that the UE is compatible with HARQ mutliplexing.

Block 308 specifies that where the multiplexing in block 304 is FDM, the frequency mutliplexed first re-transmissions are scheduled by separately scheduled (separate PDCCHs for LTE/LTE-A). Block 310 provides the opposite, where the multiplexing in block 304 is SDM, the spatially mutliplexed first re-transmissions are scheduled with a single physical downlink control channel PDCCH.

Further within the framework of the SDM multiplexing, block 312 summarizes the new DCI formats detailed above. Specifically, the format for the PDCCH used in block 310 has a) a separate process identifier for each HARQ process for which re-transmitted data is spatially multiplexed, and b) a separate transport block index associated with each of the process identifiers. As detailed above any given process identifier and its associated transport block will uniquely identify a HARQ buffer for the UE.

The logic diagram of FIG. 3 may be considered to illustrate the operation of a method, and a result of execution of a computer program stored in a computer readable memory, and a specific manner in which components of an electronic device are configured to cause that electronic device to operate, whether such an electronic device is the eNB or access node of some other network (including remote radio heads and relays), or one or more components thereof such as a modem, chipset, or the like. The various blocks shown in FIG. 3 may also be considered as a plurality of coupled logic circuit elements constructed to carry out the associated function(s), or specific result of strings of computer program code or instructions stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Such circuit/circuitry embodiments include any of the following: (a) hardware-only circuit implementations (such as implementations in only analog and/or digital circuitry) and (b) combinations of circuits and software (and/or firmware), such as: (i) a combination of processor(s) or (ii) portions of processor(s)/software (including digital signal processor(s)), software, and memory(ies) that work together to cause an apparatus, such as a network access node/eNB, to perform the various functions summarized at FIG. 3 and (c) circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” also covers, for example, a baseband integrated circuit or applications processor integrated circuit for a network access node/eNB or a similar integrated circuit in a server or other network device which operates according to these teachings.

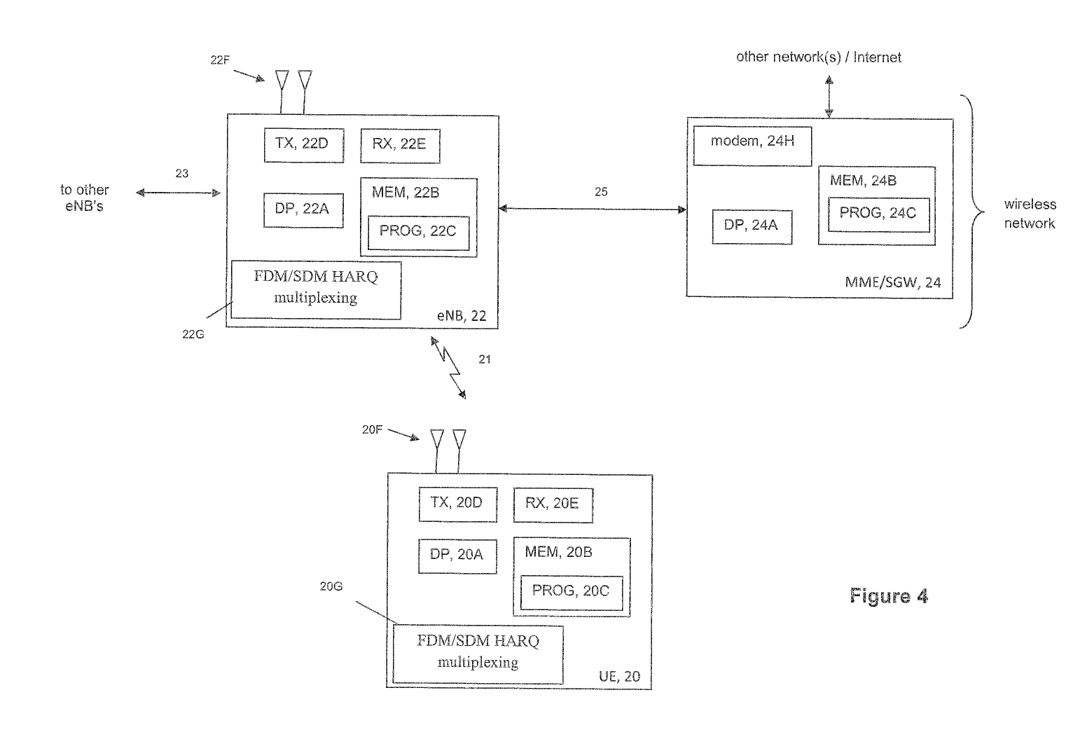

Reference is now made to FIG. 4 for illustrating a simplified block diagram of various electronic devices and apparatus that are suitable for use in practicing the exemplary embodiments of this invention. In FIG. 4 an eNB 22 is adapted for communication over a wireless link 21 with an apparatus, such as a mobile terminal or UE 20. The eNB 22 may be any access node (including frequency selective repeaters) of any wireless network using licensed (and in some embodiments also unlicensed) bands, such as LTE, LTE-A, GSM, GERAN, WCDMA, and the like. The operator network of which the eNB 22 is a part may also include a network control element such as a mobility management entity MME and/or serving gateway SGW 24 or radio network controller RNC which provides connectivity with further networks (e.g., a publicly switched telephone network PSTN and/or a data communications network/Internet).

The UE 20 includes processing means such as at least one data processor (DP) 20A, storing means such as at least one computer-readable memory (MEM) 20B storing at least one computer program (PROG) 20C, communicating means such as a transmitter TX 20D and a receiver RX 20E for bidirectional wireless communications with the eNB 22 via one or more antennas 20F. Also stored in the MEM 20B at reference number 20G are the algorithms or look-up tables by which the UE 20 can determine when HARQ mutliplexing is in use and what HARQ buffers to use with re-transmitted data it receives that is multiplexed with other re-transmitted data from other HARQ processes in other HARQ buffers, as variously described in the embodiments above.

The eNB 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F. The eNB 22 stores at block 22G similar algorithms/look-up tables for choosing when and how to SDM or FDM data re-transmissions to the UE, similar as detailed above for the UE at block 20G.

While not particularly illustrated for the UE 20 or eNB 22, those devices are also assumed to include as part of their wireless communicating means a modem and/or a chipset which may or may not be inbuilt onto an RF front end chip within those devices 20, 22 and which also operates utilizing rules for frequency and/or spatially multiplexing HARQ re-transmission data as set forth in detail above.

At least one of the PROGs 20C in the UE 20 is assumed to include a set of program instructions that, when executed by the associated DP 20A, enable the device to operate in accordance with the exemplary embodiments of this invention, as detailed above. The eNB 22 also has software stored in its MEM 22B to implement certain aspects of these teachings such as those specifically summarized at FIG. 3. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire devices as depicted at FIG. 4 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Interne appliances.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like.

Various embodiments of the DPs 20A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE and LTE-A systems, as noted above the exemplary embodiments of this invention are not limited for use with only this one particular type of wireless communication system.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. A method for controlling a wireless network access node, comprising:
sending data blocks in a first radio frame having a first configuration of uplink to downlink transmission time intervals, each data block originating a separate hybrid automatic repeat request HARQ process; and
frequency or spatially mutliplexing first re-transmissions of at least two of the data blocks in at least one transmission time interval of a sequentially next second radio frame having a second configuration of uplink to downlink transmission time intervals.

2. The method according to claim 1, wherein the method is conditional on the wireless network access node configuring HARQ multiplexing.

3. The method according to claim 1, wherein the frequency or spatially multiplexed first re-transmissions are sent to a user equipment conditional on the network access node receiving from the user equipment an indication that the user equipment is compatible with HARQ mutliplexing.

4. The method according to claim 1, wherein the multiplexing is frequency domain multiplexing and the frequency mutliplexed first re-transmissions are separately scheduled.

5. The method according to claim 1, wherein the multiplexing is spatial domain multiplexing and the spatially mutliplexed first re-transmissions are scheduled with a single physical downlink control channel PDCCH.

6. The method according to claim 5, wherein a format for the PDCCH comprises at least a separate process identifier for each HARQ process for which re-transmitted data is spatially multiplexed.

7. The method according to claim 6, wherein the format for the PDCCH further comprises a separate transport block index associated with each of the process identifiers, such that the process identifier and its associated transport block uniquely identify a HARQ buffer.

8. The method according to claim 1, wherein the wireless network access node is an eNB operating in a LTE or LTE-A radio access technology network.

9. An apparatus for controlling a wireless network access node, the apparatus comprising a processing system which comprises at least one processor and a memory storing a set of computer instructions;
wherein the processing system is configured to cause the apparatus at least to:
send data blocks in a first radio frame having a first configuration of uplink to downlink transmission time intervals, each data block originating a separate hybrid automatic repeat request HARQ process; and
frequency or spatially mutliplex first re-transmissions of at least two of the data blocks in at least one transmission time interval of a sequentially next second radio frame having a second configuration of uplink to downlink transmission time intervals.

10. The apparatus according to claim 9, wherein execution by the at least one processor of the set of computer instructions is conditional on the wireless network access node configuring HARQ multiplexing.

11. The apparatus according to claim 9, wherein the frequency or spatially multiplexed first re-transmissions are sent to a user equipment conditional on the network access node receiving from the user equipment an indication that the user equipment is compatible with HARQ mutliplexing.

12. The apparatus according to claim 9, wherein the multiplexing is frequency domain multiplexing and the frequency mutliplexed first re-transmissions are separately scheduled.

13. The apparatus according to claim 9, wherein the multiplexing is spatial domain multiplexing and the spatially mutliplexed first re-transmissions are scheduled with a single physical downlink control channel PDCCH.

14. The apparatus according to claim 13, wherein a format for the PDCCH comprises at least a separate process identifier for each HARQ process for which re-transmitted data is spatially multiplexed.

15. The apparatus according to claim 14, wherein the format for the PDCCH further comprises a separate transport block index associated with each of the process identifiers, such that the process identifier and its associated transport block uniquely identify a HARQ buffer.

16. The apparatus according to claim 14, wherein the wireless network access node is an eNB operating in a LTE or LTE-A radio access technology network.

17. A computer readable memory tangibly storing a set of computer executable instructions for controlling a wireless network access node, the set of computer executable instructions comprising:
code for sending data blocks in a first radio frame having a first configuration of uplink to downlink transmission time intervals, each data block originating a separate hybrid automatic repeat request HARQ process; and
code for frequency or spatially mutliplexing first re-transmissions of at least two of the data blocks in at least one transmission time interval of a sequentially next second radio frame having a second configuration of uplink to downlink transmission time intervals.

18. The computer readable memory according to claim 17, wherein set of computer executable instructions is executable conditional on the wireless network access node configuring HARQ multiplexing.

19. The computer readable memory according to claim 17, wherein the frequency or spatially multiplexed first re-transmissions are sent to a user equipment conditional on the network access node receiving from the user equipment an indication that the user equipment is compatible with HARQ mutliplexing.

20. The computer readable memory according to claim 17, wherein the multiplexing is frequency domain multiplexing and the frequency mutliplexed first re-transmissions are separately scheduled.

21-24. (canceled)
